(19) United States
(12) Patent Application Publication
(10) Pub. No.: US 2024/0269025 A1
(43) Pub. Date: Aug. 15, 2024

(54) Catheter Bag Hanger Device

(71) Applicant: Phyllis Williams, Akron, OH (US)

(72) Inventor: Phyllis Williams, Akron, OH (US)

(21) Appl. No.: 18/485,394

(22) Filed: Oct. 12, 2023

Related U.S. Application Data
(60) Provisional application No. 63/444,316, filed on Feb. 9, 2023.

(51) Int. Cl. A61G 7/05

(52) U.S. Cl. CPC A61G 7/0503

(57) ABSTRACT

A catheter bag hanger device is provided. The is comprised of an L-shaped body that can be partially positioned under a patient's body on a stretcher, exam table, hospital bed, etc. The device positions a catheter bag in a vertical position such that urine or fluids from the catheter bag cannot back up through the catheter tubing and cause infection.

### CROSS-REFERENCE TO RELATED APPLICATION

The present application claims priority to, and the benefit of, U.S. Provisional Application No. 63/444,316, which was filed on Feb. 9, 2023, and is incorporated herein by reference in its entirety.

### FIELD OF THE INVENTION

The present invention relates generally to the field of medical catheters. More specifically, the present invention relates to a catheter bag hanger device. The device positions a catheter bag vertically relative to the patient such that urine or fluids from the catheter bag cannot back up through the catheter tubing. Accordingly, the present disclosure makes specific reference thereto. Nonetheless, it is to be appreciated that aspects of the present invention are also equally applicable to other like applications, devices, and methods of manufacture.

### BACKGROUND

An individual with a Foley catheter also wears or carries a catheter bag. The bag collects urine from the catheter. While on a stretcher, an exam table, a hospital bed, etc., urine may back up into the catheter tubing from a catheter bag due to the positioning of the bag. This is undesirable as it can cause infection.

Therefore, there exists a long-felt need in the art for a device that prevents urine from backing up from a catheter bag. More specifically, there exists a long-felt need in the art for a catheter bag hanger device that can be used to position a catheter bag such that urine cannot back up from the catheter bag. In addition, there exists a long-felt need in the art for a catheter bag hanger device that can be used to position a catheter bag such that urine cannot back up from the catheter bag while a user is on a stretcher or an exam table.

The subject matter disclosed and claimed herein, in one embodiment thereof, comprises a catheter bag hanger device. The device is comprised of a catheter bag hanger device preferably comprised of a first wall attached to a second wall, wherein the second side wall is comprised of at least one opening. The device is designed to be used as an anchor point for a catheter bag. The second wall preferably perpendicularly attaches to the first wall such that the device forms a general L-shape that can be placed under a patient on a hospital bed, exam table, stretcher, etc. The opening of the device can receive the clip of a catheter bag to suspend the bag vertically such that urine cannot back up from the bag (which occurs when the bag becomes horizontal).

In this manner, the catheter bag hanger device of the present invention accomplishes all the foregoing objectives and provides a device that prevents urine from backing up from a catheter bag, and that can be used to position a catheter bag such that urine cannot back up from the catheter bag, for example, when a user is on a stretcher or on an exam table.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a catheter bag hanger device preferably comprised of a first wall attached to a second wall, wherein the second side wall is comprised of at least one opening. The device is designed to be used as an anchor point for a catheter bag. The second wall preferably perpendicularly attaches to the first wall such that the device forms a general L-shape. In one embodiment, the second wall attaches to the first wall via at least one hinge that allows the second wall to be repositioned relative to the first wall to form a plurality of angles.

The first wall is designed to be placed under a patient during use. As a result, the edges of the first wall (and the edges of the second wall) are preferably rounded to prevent the edges from causing discomfort to the patient. In one embodiment, the bottom surface and/or top surface of the first wall is comprised of at least one fastener that allows the first wall to be attached to a hospital bed and/or a user's leg. The first wall may also be comprised of at least one padding on the top surface that increases the comfort of the user while the user's leg/body rests on the first wall during use.

The second wall is comprised of at least one opening that allows a clip of a catheter bag to be secured to the second wall, such that the catheter bag is suspended by the second wall. In addition, or in lieu of the opening, the front surface of the second wall may also have at least one fastener that secures the catheter bag to the second wall. Said fastener may include, but is not limited to, a clip, a clamp, a hook, etc. In addition, the opening may also receive tubes of a catheter bag for organization/routing purposes.

The present invention is also comprised of a method of using the device. First, a device is provided comprised of a first wall attached to a second wall, wherein the second wall is comprised of at least one opening. Then, a clip/handle of a catheter bag (or in another embodiment, a chest tube bag) is placed into the opening of the second wall such that the bag hangs from the second wall. Next, the first wall can be inserted under the leg/body of a patient to keep the device in a position, such that the bag hangs parallel to the second wall to prevent the bag from backing up.

Accordingly, the catheter bag hanger device of the present invention is particularly advantageous as it provides a device that prevents urine from backing up from a catheter bag. More specifically, the device can be used to position a catheter bag such that urine cannot back up from the catheter bag while a user is on a stretcher or on an exam table. In this manner, the catheter bag hanger device overcomes the limitations of existing methods of using catheter bags known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a catheter bag hanger device of the present invention resting on a hospital bed in accordance with the disclosed architecture;

FIG. 2 illustrates a side view of one potential embodiment of a catheter bag hanger device of the present invention in accordance with the disclosed architecture;

FIG. 3 illustrates a side view of one potential embodiment of a catheter bag hanger device of the present invention positioned between a patient and a hospital bed in accordance with the disclosed architecture; and

FIG. 4 illustrates a flowchart of a method of using one potential embodiment of a catheter bag hanger device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that prevents urine from backing up from a catheter bag. More specifically, there exists a long-felt need in the art for a catheter bag hanger device that can be used to position a catheter bag such that urine cannot back up from the catheter bag. In addition, there exists a long-felt need in the art for a catheter bag hanger device that can be used to position a catheter bag such that urine cannot back up from the catheter bag while a user is on a stretcher or an exam table.

The present invention, in one exemplary embodiment, is comprised of a catheter bag hanger device comprised of a first wall attached to a second wall, wherein the second side wall is comprised of at least one opening. The device is designed to be used as an anchor point for a catheter bag. The second wall preferably perpendicularly attaches to the first wall such that the device forms a general L-shape. The second wall may attach to the first wall via at least one hinge that allows the second wall to be repositioned relative to the first wall to form a plurality of angles.

The first wall is designed to be placed under a patient during use. Therefore, the edges of the first wall (and the edges of the second wall) are preferably rounded to prevent the edges from causing discomfort to the patient. In one embodiment, the bottom surface and/or top surface of the first wall is comprised of at least one fastener. The fastener allows the first wall to be attached to a hospital bed and/or a user's leg. The first wall may also be comprised of at least one padding on the top surface that increases the comfort of the user while the user's leg/body rests on the first wall during use.

The second wall is comprised of at least one opening. The opening allows a clip of a catheter bag to be secured to the second wall such that the catheter bag is suspended by the second wall. In addition, or in lieu of the opening, the front surface of the second wall may also have at least one fastener that secures the catheter bag to the second wall. Said fastener may include, but is not limited to, a clip, a clamp, a hook, etc. In addition, the opening may also receive tubes of a catheter bag for organization/routing purposes.

The present invention is also comprised of a method of using the device. First, a device is provided comprised of a first wall attached to a second wall, wherein the second wall is comprised of at least one opening. Then, a clip/handle of a catheter bag (or in another embodiment, a chest tube bag) is placed into the opening of the second wall such that the bag hangs from the second wall. Next, the first wall can be inserted under the leg/body of a patient to keep the device in position such that the bag hangs parallel to the second wall to prevent the bag from backing up.

Accordingly, the catheter bag hanger device of the present invention is particularly advantageous as it provides a device that prevents urine from backing up from a catheter bag. More specifically, the device can be used to position a catheter bag such that urine cannot back up from the catheter bag while a user is on a stretcher or an exam table. In this manner, the catheter bag hanger device overcomes the limitations of existing methods of using catheter bags known in the art.

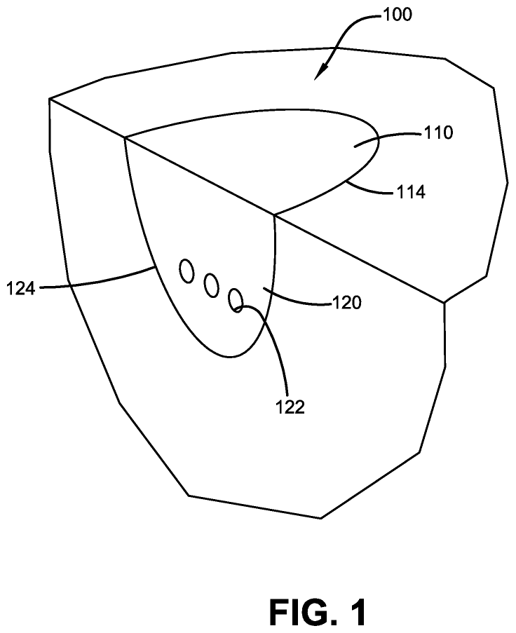

Referring initially to the drawings, FIG. 1 illustrates a perspective view of one potential embodiment of a catheter bag hanger device 100 of the present invention resting on a hospital bed 30 in accordance with the disclosed architecture. The device 100 is preferably comprised of a first wall 110 attached to a second wall 120, wherein the second side wall 120 is comprised of at least one opening 122. The device 100 is designed to be used as an anchor point for a catheter bag 10.

In differing embodiments, the first wall 110 and second wall 120 may be made from any rigid or flexible material known in the art. Said material includes a metal such as, but not limited to, stainless steel or aluminum. Said material also includes plexiglass or plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc.

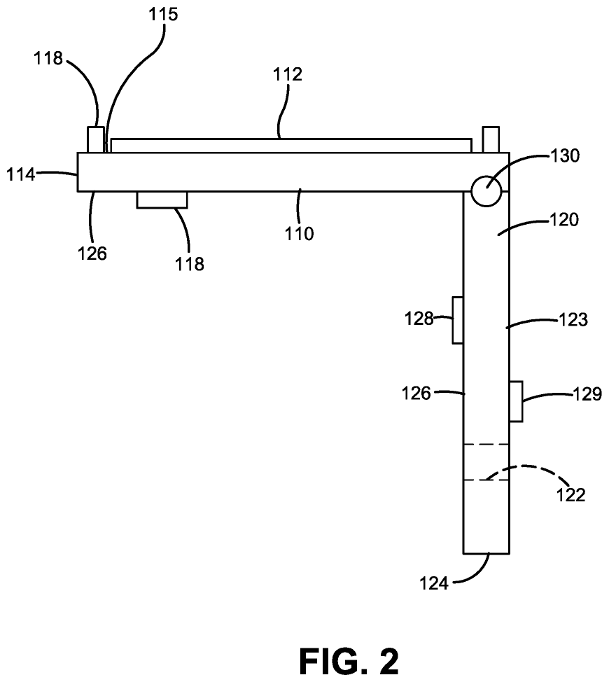

The second wall 120 preferably perpendicularly attaches to the first wall 110 such that the device 100 forms a general L-shape. However, in different embodiments the first wall 110 and second wall 120 may attach to form any angle between 0 and 180 degrees. In one embodiment, the second wall 120 attaches to the first wall 110 via at least one hinge 130, as seen in FIG. 2. The hinge 130 allows the second wall 120 to be repositioned relative to the first wall 10 to form a plurality of angles, which is advantageous depending on the area the device 100 is being used in. The hinge 130 is preferably a locking hinge but may be any hinge type known in the art.

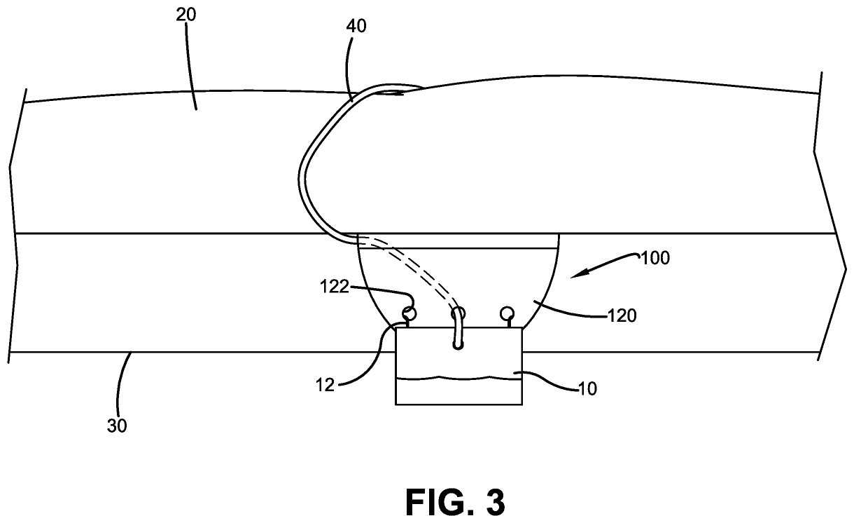

The first wall 110 is designed to be placed under a patient during use, as seen in FIG. 3. As a result, the edges 114 of the first wall 110 (and the edges 124 of the second wall 120) are preferably rounded to prevent the edges 114 from causing discomfort to the patient 20. In one embodiment, the bottom surface 116 and/or top surface 115 of the first wall 110 is comprised of at least one fastener 118. The fastener 118 allows the first wall 110 to be attached to a hospital bed 30 and/or a user's 20 leg. The fastener 118 may include, but is not limited to, an adjustable strap, hook and loop, magnet, adhesive, etc.

The first wall 110 may also be comprised of at least one padding 112 on the top surface 115. The padding 112 is preferably a foam padding, but may be any padding type known in the art. The padding 112 increases the comfort of the user while the user's 20 leg/body rests on the first wall 110 during use.

The second wall 120 is comprised of at least one opening 122. The opening 122 may be positioned anywhere on the second wall 120 and allows a clip 12 of a catheter bag 10 to be secured to the second wall 120 such that the catheter bag 10 is suspended by the second wall 120. The second wall 120 may be comprised of at least one fastener 128 on the rear surface 126 of the wall 120 that allows the wall 120 to attach to a hospital bed 30, exam table, stretcher, etc. The fastener 128 may be any type known in the art, but is preferably a hook and loop fastener, a magnet fastener, a clip fastener, or a clamp fastener. In addition, or in lieu of the opening 122, the front surface 123 of the second wall 120 may also have at least one fastener 129 that secures the catheter bag 10 to the second wall 120. Said fastener 129 may include, but is not limited to, a clip, a clamp, a hook, etc. The opening 122 may also receive tubes 40 of a catheter bag 10 for organization/routing purposes.

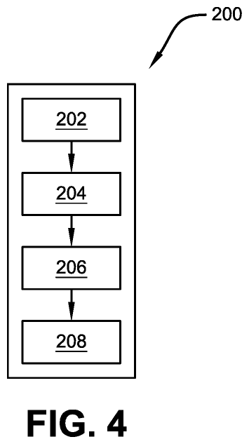

The present invention is also comprised of a method of using 200 the device 100, as seen in FIG. 4. First, a device 100 is provided comprised of a first wall 110 attached to a second wall 120, wherein the second wall 120 is comprised of at least one opening 122 [Step 202]. Then, a clip/handle 12 of a catheter bag 10 (or in another embodiment, a chest tube bag) is placed into the opening 122 of the second wall 120 such that the bag 10 hangs from the second wall 120 [Step 204]. In an embodiment of the device 100 with a fastener 129, the fastener 129 can also be used to secure the bag 10 to the second wall 120. Next, the first wall 110 can be inserted under the leg/body of a patient 20 to keep the device 100 in position, such that the bag 10 hangs parallel to the second wall 120 to prevent the bag from backing up [Step 206]. In an embodiment of the device 100 with fasteners 118,128, the fasteners 118,128 may be used to secure the device 100 to a hospital bed 30, exam table, stretcher, etc., and/or to the user's body [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “catheter bag hanger device” and “device” are interchangeable and refer to the catheter bag hanger device 100 of the present invention.

Notwithstanding the foregoing, the catheter bag hanger device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the catheter bag hanger device 100 as shown in the FIGS. are for illustrative purposes only, and that many other sizes and shapes of the catheter bag hanger device 100 are well within the scope of the present disclosure. Although the dimensions of the catheter bag hanger device 100 are important design parameters for user convenience, the catheter bag hanger device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A catheter bag hanger device comprising:
a first wall; and
a second wall perpendicularly attached to the first wall, the second wall comprised of an opening.

2. The catheter bag hanger device of claim 1, wherein the first wall is comprised of a plexiglass material.

3. The catheter bag hanger device of claim 1, wherein the second wall is comprised of a plexiglass material.

4. The catheter bag hanger device of claim 1, wherein the first wall is comprised of a rounded edge.

5. The catheter bag hanger device of claim 1, wherein the second wall is comprised of a rounded edge.

6. A catheter bag hanger device comprising:
a first wall comprised of a padding; and
a second wall perpendicularly attached to the first wall via a hinge, the second wall comprised of an opening and a first fastener.

7. The catheter bag hanger device of claim 6, wherein the padding is comprised of a foam padding.

8. The catheter bag hanger device of claim 6, wherein the padding is positioned on a top surface of the first wall.

9. The catheter bag hanger device of claim 6, wherein the first fastener is comprised of a clip, a clamp, or a hook.

10. The catheter bag hanger device of claim 6, wherein a rear surface of the second wall is comprised of a second fastener.

11. The catheter bag hanger device of claim 10, wherein the second fastener is comprised of a hook and loop fastener, a magnet fastener, a clip fastener, or a clamp fastener.

12. The catheter bag hanger device of claim 6, wherein a top surface of the first wall is comprised of a third fastener.

13. The catheter bag hanger device of claim 12, wherein the third fastener is comprised of an adjustable strap.

14. The catheter bag hanger device of claim 6, wherein the hinge is comprised of a locking hinge.

15. A method of using a catheter bag hanger device, the method comprising the following steps:
providing a catheter bag hanger device comprised of a first wall attached to a second wall, wherein the second wall is comprised of an opening;
placing a clip of a bag into the opening such that the bag hangs from the second wall; and
inserting the first wall under a body of a patient.

16. The method of claim 15, wherein the bag is comprised of a catheter bag.

17. The method of claim 15, wherein the bag is comprised of a chest tube bag.

18. The method of claim 15 further comprised of a step of securing the bag to the second wall via a first fastener.

19. The method of claim 15 further comprised of a step of securing the first wall to the body of a patient via a second fastener.

20. The method of claim 15 further comprised of a step of securing the first wall or the second wall to a hospital bed via a third fastener.
